(19) United States
(12) Patent Application Publication
(10) Pub. No.: US 2024/0069657 A1
(43) Pub. Date: Feb. 29, 2024

(54) Mystical Mate

(71) Applicant: paul campagna, indiana, PA (US)

(72) Inventor: paul campagna, indiana, PA (US)

(21) Appl. No.: 17/822,523

(22) Filed: Aug. 26, 2022

(51) Int. Cl. G06F 3/039; G06F 3/0354

(52) U.S. Cl. CPC G06F 3/039; G06F 3/03543

(57) ABSTRACT

The present invention comprises a new device that when combined with existing mice that are designed to lay flat and not ergonomically adjustable. In Addition to making the existing device ergonomic, it also adds additional functions that the original device did not have previously. This includes a middle click and speed adjustments that are all controllable with (one hand). This makes a completely new ergonomically adjustable device the adds functions and combines the features of both items. The new device takes over the pointer function and has it's own electronics to control said functions.

Some devices in the market already come with adjustments for ergonomics and buttons that control functions, such as middle click and adjust mouse speed, but there is not a device that combines existing devices without these benefits and creates a new mouse device that can be controlled using only one hand.

The current invention work in conjunction with existing mice/computer control apparatuses to make the hand position adjustable and more ergonomic, while also adding Additional one hand mouse functions to the original mouse. More specifically the invention combines existing non-adjustable, one button mouse device with the Mystical Mate to make the hand position adjustable and add additional mouse functions and control Using one hand.

### BACKGROUND

Currently some existing mouse devices have a flat hand placement which affects the comfort level for some people when your hand is in a flat position, it can cause strain on your wrist and discomfort, (especially with extended use). Some current mouse devices with limited one hand functions also does not have a dedicated “middle click” button. These one button mice have one big button with touch sensitive, (location specific) areas for “Left” and “Right” clicks. This is on one big surface, but no “Middle” click specific button. As well as no middle click, the mouse tracking speed is not adjustable from the mouse itself. Multiple steps are needed through the computers interface to adjust speed. The invention works in conjunction with existing one button non-adjustable mice making the hand position adjustable, while also adding a dedicated middle click and mouse tracking speed buttons all accessible with on hand on the mouse.

The problem with having no dedicated middle click button on the one button mouse is that it makes it very difficult to use the mouse in situations and programs that use dedicated, “Middle” clicks to accomplish simple tasks. Computer Aided Drafting, (CAD) programs, 3D Design programs, Word Processing programs, Games, etc. These all have specific functions that are executed with a middle click button. Not having one limits the use of the mouse in these situations. This is also the case for the speed of the cursor. Having a quick and easy one-click button that changes the tracking speed, would be beneficial in many areas, including gaming.

There are keyboard shortcuts to activate the middle click function, but having a one click, isolated middle button on devices with only one physical button does not exist.

The factory adjustments for the mouse speed are also limited and require going into the “Settings” menu, which require many clicks and time to make adjustments. This is the only device that combines to a existing devices without speed adjustment and adds a physical button for one hand and one click mouse tracking speed changes.

Therefore, a need exists in the field for a device that not only makes the devices with limited positioning adjustable and more comfortable, but also adds a dedicated physical middle click and speed control buttons that are accessible by using only your mouse hand.

### BRIEF SUMMARY OF THE INVENTION

The present invention is comprised of a bottom and 4 walls that “hold” the original one button device up off the desk. The “holder” moves the original one button flat designed mouse into an angular position and takes over the mouse pointer controls, while adding additional buttons on the side of the device for addition one hand functions, such as middle click and cursor speed adjustments.

### BRIEF DESCRIPTION OF THE DRAWINGS

Some embodiments of the present invention are illustrated as an example and are not limited by the figures of the accompanying drawings, in which like references may indicate similar elements and in which:

Drawing 1-A shows an exploded view off all the component (minus the circuit board)

Drawing 1-B shows all components minus the circuit board

FIG. 1—Depicts the example one button, flat designed mouse for which the device was designed for.

FIG. 2—FIG. 2 illustrates a perspective view of the first clip. That clip attaches to the one button flat devices bottom rails and attach the one button device combining to create a new one hand controlled device with new physical buttons.

FIG. 3—FIG. 3 depicts the new lever/button element used for a “middle” click function

FIG. 4—FIG. 4 depicts the mouse cursor speed button

FIG. 5—FIG. 5 depicts the base holder for all of the components minus circuits and battery

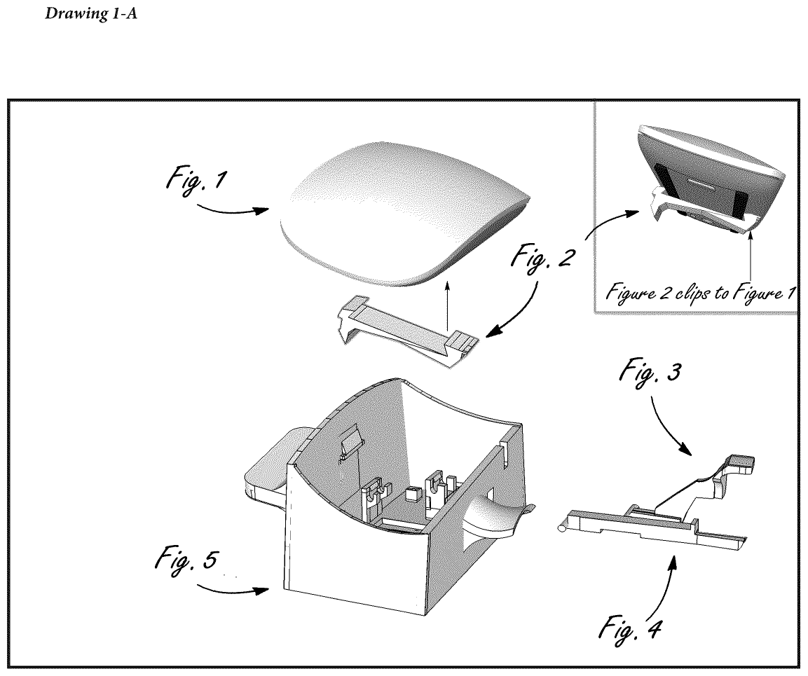

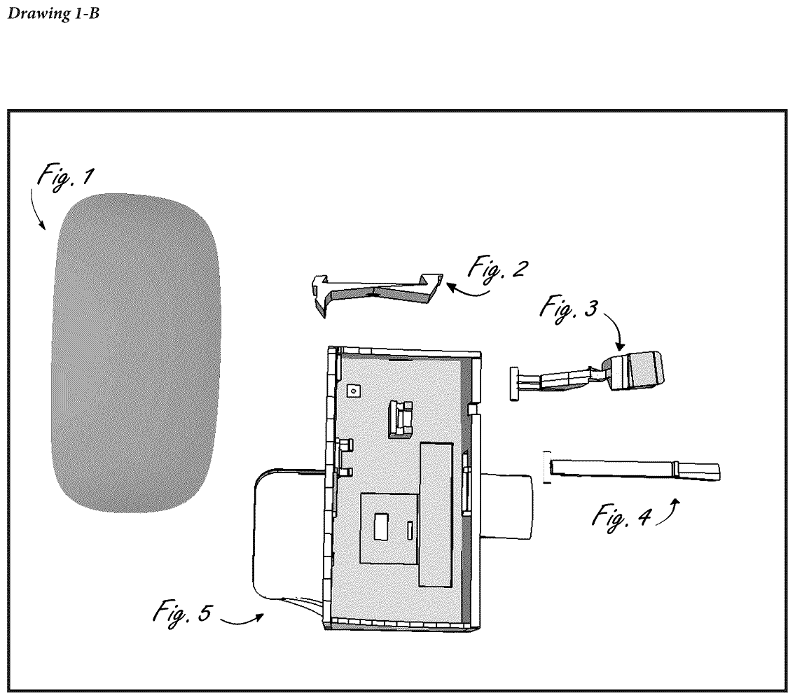

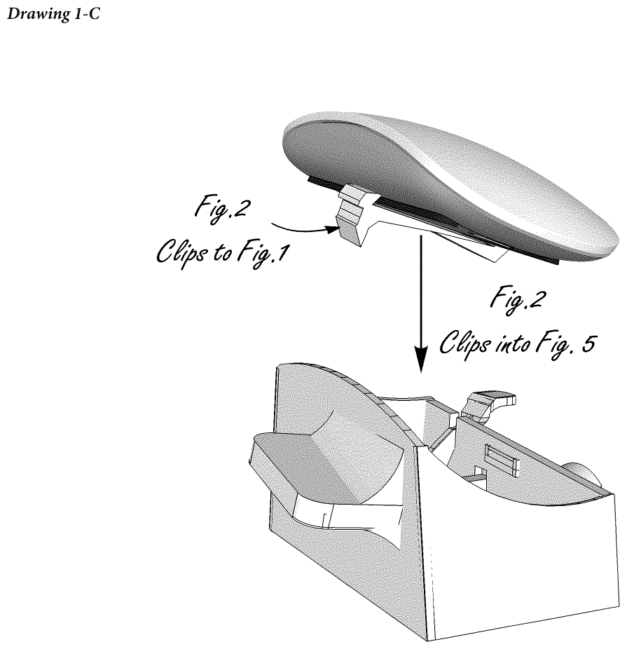

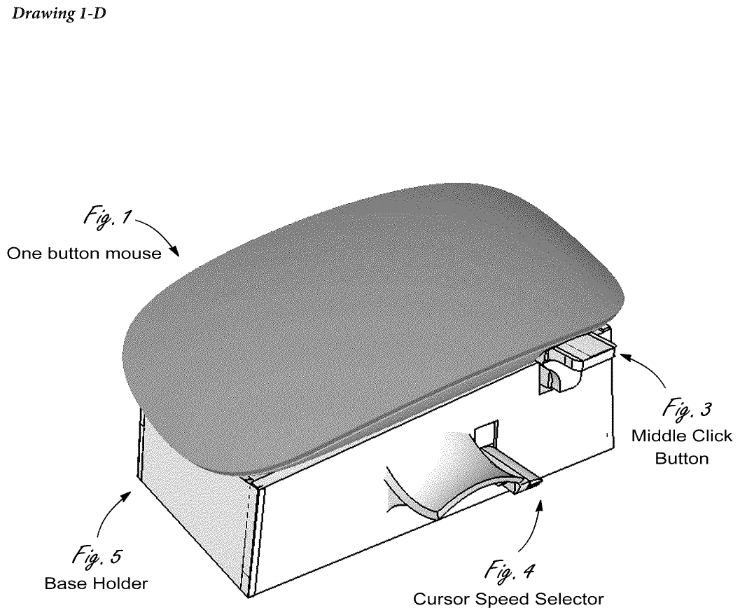

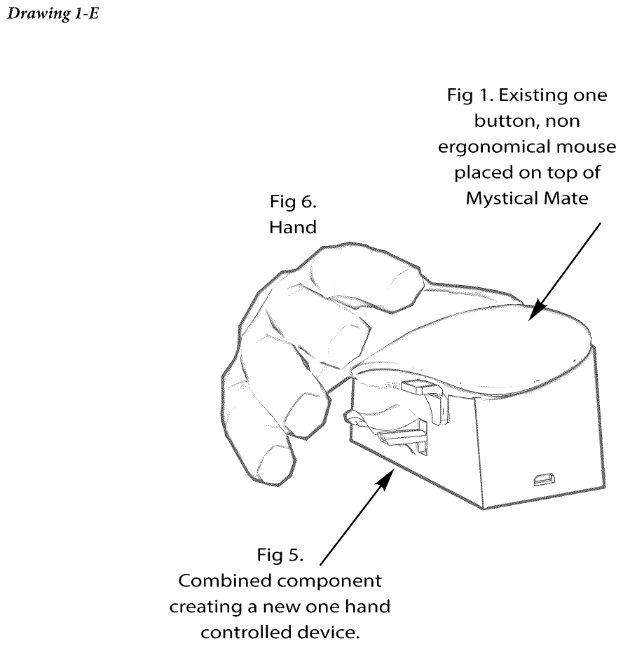

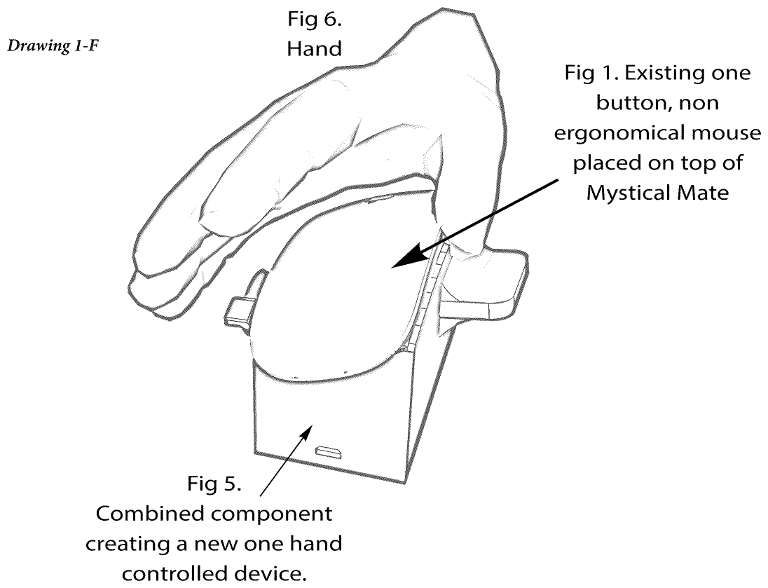

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a”, “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that each component is combined to create a new one handed controlled device.

The present invention will now be described by referencing the appended figures representing preferred embodiments. Drawing 1-A depicts an exploded perspective view of the elements that may comprise the compound mouse device (the “device”)

Drawing 1-A and Drawing 1-B show the components that make up the new device.

In Drawing 1-A and 1-B FIG. 1 represents the original one button device that is not ergonomically adjustable and does not have physical buttons for additional functions, such as a middle click and cursor speed adjustments.

Drawing 1-D illustrates a side profile view of an example of some of the components which make up the new device

Drawing 1-E illustrates the hand position when using the new combined device allowing for one hand control of all of the functions.

Drawing 1-F illustrated the hand position from a top view and the combined one button original device attached the new Mystical Mate device.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed:

1. The proposed device adds additional one hand functions when combined to the original one button device that did not have these functions previously,
a. An adjustable more ergonomic position when they are combined with a device the flat one button device;
b. A dedicated “center” button with one hand control when combined with a device with only one button
c. A dedicated mouse “cursor speed adjustment” button when combined
d. Additional buttons can also be added.
